(19) United States
(12) Patent Application Publication
(10) Pub. No.: US 2025/0384141 A1
(43) Pub. Date: Dec. 18, 2025

(54) METHOD AND SYSTEM FOR SECURITY TESTING BOARD FOR REMOTE ECU ACCESS

(71) Applicant: Robert Bosch GmbH, Stuttgart (DE)

(72) Inventors: Shalabh JAIN, Pittsburgh, PA (US); Jorge GUAJARDO MERCHAN, Pittsburgh, PA (US); Sekar KULANDAIVEL, Pittsburgh, PA (US)

(21) Appl. No.: 18/743,734

(22) Filed: Jun. 14, 2024

(51) Int. Cl. G06F 21/57; H04L 12/40

(52) U.S. Cl. CPC G06F 21/577; H04L 12/40; G06F 2221/034; H04L 2012/40215; H04L 2012/40273

(57) ABSTRACT

An apparatus utilized for security testing one or more electronic control units (ECUs) includes a memory unit configured to store one or more instructions, a controller configured to execute one or more instructions, a control network interface in communication with the controller and that is configured to communicate instructions received from one or more control networks, a breakout interface configured to send one or more instructions to the one or more ECUs, a automotive network interface configured to communicate with one or more automotive networks, a general purpose input-output (GPIO) breakout interface including a plurality of GPIO pins configured to send signals to control functionality of the apparatus, a power interface configured to supply variable power to the one or more ECUS, and one or more debug interfaces configured to allow communication between a debugger and the one or more ECUs as associated with security testing.

### TECHNICAL FIELD

The present disclosure relates to testing of electronic control units (ECUs), including those on automotive vehicle networks.

### BACKGROUND

With an increase in the electronic components within a car, availability of external interfaces and the mass availability of tools and knowledge, threats and attacks in the automotive domain have seen an exponential increase. Early detection of potential vulnerabilities may be important to ensure security of such systems.

Several traditional techniques for vulnerability detection, such as static code analysis, fuzzing, etc. have been deployed or are being designed for future systems. However, unlike traditional software systems for PCs, cyber-physical systems in the automotive domain have attacked vectors that span beyond the software, and into the physical and hardware realm. Thus, usage of pure software based to techniques is insufficient.

Unlike software systems, testing hardware systems for security poses significant scalability problems. To test a subsystem, consisting of multiple ECUs, one typically requires the hardware for the ECUs, and the ability to connect them to form a subsystem. Additionally, reconfiguration of such systems or introduction of attack vectors typically requires physical changes to the hardware.

Several recent efforts in the academic and industrial community have aimed at providing virtual access to these physical devices to address the issue of remote availability of hardware. However, the flexibility to exercise different attack vectors in these ECUs is still unavailable.

### SUMMARY

A first illustrative embodiment discloses an apparatus utilized for security testing one or more electronic control units (ECUs) includes a memory unit configured to store one or more instructions, a controller configured to execute one or more instructions, a control network interface in communication with the controller, wherein the control network interface is configured to communication instructions received from one or more control networks, a breakout interface configured to communicate with the one or more ECUs, wherein the breakout interface is configured to send one or more instructions to the one or more ECU, a automotive network interface configured to communicate with one or more automotive networks, a general purpose input-output (GPIO) breakout interface including a plurality of GPIO pins configured to send signals to control functionality of the apparatus, a power interface configured to supply variable power to the one or more ECUS, and one or more debug interfaces configured to allow communication between a debugger and the one or more ECUs as associated with security testing.

A second illustrative embodiment discloses an apparatus utilized for security testing one or more ECUs, in which the apparatus includes a memory unit configured to store one or more instructions, a controller configured to execute one or more instructions, a control network interface in communication with the controller, wherein the control network interface is configured to communication instructions received from one or more control networks, a breakout interface configured to communicate with the one or more ECUs, wherein the breakout interface is configured to send the one or more instructions to the one or more ECU, a automotive network interface configured to communicate signals to one or more automotive networks, a GPIO breakout interface including a plurality of GPIO pins configured to send signals to control functionality of the apparatus, and one or more debug interfaces configured to allow communication between a debugger and the one or more ECUs.

A third illustrative embodiment discloses an electronic board utilized for testing one or more ECUs. The board includes a memory unit configured to store one or more instructions, a controller configured to execute one or more instructions, a control network interface in communication with the controller, wherein the control network interface is configured to communication instructions received from one or more control networks, a breakout interface configured to communicate with the one or more ECUs, wherein the breakout interface is configured to send the one or more instructions to the one or more ECU, a automotive network interface configured to communicate signals to one or more automotive networks, and a GPIO breakout interface including a plurality of GPIO pins configured to send signals to control functionality of the apparatus, wherein the controller is further configured to monitor interaction of the one or more ECUS in response to signals at one or more automotive networks and the signals sent by the GPIO breakout interface.

### BRIEF DESCRIPTION OF THE DRAWINGS

FIG. 1 illustrates an embodiment of a system overview of a testing board interacting with networks and an electronic control unit (ECU).

FIG. 2 illustrates an embodiment of an overview of a controller area network (CAN) interface.

FIG. 3 illustrates an embodiment of an overview of an ECU interface.

FIG. 4 illustrates an embodiment of an overview of a general purpose interface.

FIG. 5 illustrates an embodiment of an exemplar security test network that can utilize the board to configure and execute security test scenarios.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative bases for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical application. Various combinations and modifications of the features consistent with the teachings of this disclosure, however, could be desired for particular applications or implementations.

“A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions.

Testing Electronic Control Units (ECUs) for security typically requires access to hardware and the ability to control different aspects of the hardware through a software interface. In this disclosure, a system and method discloses a testing board that provides security relevant access to a device under test, by enabling fine grained control of different hardware aspects of the device.

In this disclosure, a novel architecture of a testing board that provides security relevant access to an ECU (or device under test) is shown. While the design of the individual boards may vary based on the class of ECUs that are considered, illustrative embodiments are explained and illustrated below. In this disclosure, one embodiment describes a testing board providing security relevant access to a device under test, such as an automotive ECU. The various components of the board along with exemplar implementations are shown. There may be a board for systems that exercise the full hardware (hardware components such as clocks, sensor inputs) and network connectivity to analyze for vulnerabilities.

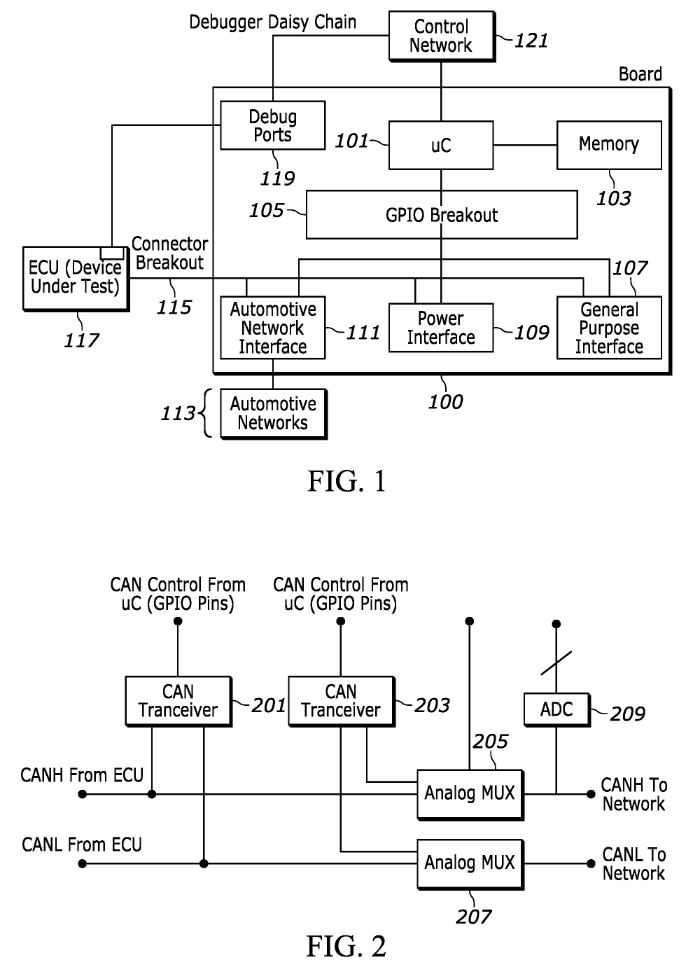

FIG. 1 illustrates an embodiment of a system overview of a testing board interacting with networks and an electronic control unit (ECU). Key components of the board 100 may include a microcontroller 101. The board 100 may include a powerful programmable microcontroller (uC) 101 with memory modules 103, network interface 111, GPIO pins 105. The micro-controller 101 can be programmed to execute arbitrary code stored in the memory 103 to control the board functionality. A network interface and controller, e.g. ethernet is present to allow connectivity to the microcontroller 101 over the network for the purpose of uploading/downloading data, controlling the microcontroller 101 (e.g. starting program execution). The microcontroller 101 may have several input/output interfaces, for example, general purpose IO (GPIO) that can be used to control different board functionality.

The microcontroller 101 may include a memory unit 103 that it communicates with. The microcontroller 101 may include one or more processors or one or more integrated circuits that implement the functionality of a central processing unit (CPU). The microcontroller 101 may be a commercially available processing unit that implements an instruction set such as one of the x86, ARM, Power, or MIPS instruction set families. During operation, the microcontroller 101 may execute stored program instructions that are retrieved from the memory unit 103. The stored program instructions may include software that controls operation of the microcontroller 101 to perform the operation described herein. In some examples, the microcontroller 101 may be a system on a chip (SoC) that integrates functionality of the microcontroller 101, the memory unit 103, a network interface, and input/output interfaces into a single integrated device.

The memory unit 103 may include volatile memory and non-volatile memory for storing instructions and data. The non-volatile memory may include solid-state memories, such as NAND flash memory, magnetic and optical storage media, or any other suitable data storage device that retains data when the computing system 103 is deactivated or loses electrical power. The volatile memory may include static and dynamic random-access memory (RAM) that stores program instructions and data. For example, the memory unit 103 may store a machine-learning model or algorithm in one embodiment. The microcontroller 101 may work with storage module 103 for controlling the board operations and network interface for remote management.

The microcontroller 101 may include a network interface to communicate with the control network 121. The network interface device may be configured to provide communication with external systems and devices. For example, the network interface device may include a wired and/or wireless Ethernet interface as defined by Institute of Electrical and Electronics Engineers (IEEE) 802.11 family of standards. The network interface device may include a cellular communication interface for communicating with a cellular network (e.g., 3G, 4G, 5G). The network interface device may be further configured to provide a communication interface to an external network (e.g. control network 121) or cloud.

The board 100 may include a general purpose input output (GPIO) breakout interface 107. The GPIO breakout interface 105 may be utilized for ECU connectors. The ECU connector may have multiple digital and analog inputs and outputs, based on functionality. The breakout cable connector may be utilized to connect the different inputs and outputs from the ECU to corresponding functions on the board. The board may provide sufficient configurable interfaces to allow connection of all pins of the supported ECUs. For example, a breakout connection may include a connection of the ECU CAN pins to the CAN interface described here, connection of the ECU power pins to the power interface connectors, and a connection of ECU sensor inputs and actuator outputs to the GPIO pins, etc. The board may include a general-purpose input-output (GPIO) interface 105 that represents an interface to the GPIO pins of the micro-controller (uC) that are connected with different control elements of the boards. For example, the GPIO pins of a connector may be used to provide control signal to the CAN interface. Another example may include the GPIO pins of the uC routed that are used to provide sensory inputs or remote connectivity to the ECU through the ECU breakout interface 107. An alternative manner may be to implement the breakout interface as a configurable breakout interface. In this scenario, the breakout interface may also be connected to a Field Programmable Array (FPGA) on one side and the FPGA connected to the microcontroller on the other. The FPGA would thus allow programmable multiplexing of breakout interface. While the breakout interface might have limited outputs, the FPGA would allow to multiplex the outputs from the microcontroller and create configurable connection to the limited breakout interface inputs.

The general purpose interface may be in communication with the one or more ECUs 117, the microcontroller 101, or other components of the board 100. The general purpose interface 107 may be controlled based on commands from the control network 121. The commands may be sent from a control network 121 that is remote from the board 100.

The board 100 may include a power interface 109. The power interface 109 may supply power to the board 100 and various components. The power interface 109 may change the amount of power that is supplied to the ECU and even various pins for monitoring. Between the power interface and the ECU, there may be a power measuring circuit or device also connected to the microcontroller or another programmable controller device that allows for the power controlling circuit or device to be configured. The configuration might include the sampling rate at which the power measuring device measures the power supply to the ECU, the power level, the amount of resistance integrated into the power measuring circuit or device, etc. The power measuring circuit or device would provide an interface (Ethernet connection, connection to memory, external connector via PCie, etc.) to collect measuring data that can be stored or extracted for further analysis. The storage of the data measured by the measuring circuit or device might be enabled on the board via additional non-volatile storage but also external to the board. The power interface 109 can also be used to supply, control and monitor the power supplied to the ECU. The control functionality may include the ability to change the voltage levels for varying amounts of time, introduce power glitches, and cut off the power supply. The board may include controlled interfaces for power networks. As such, the board may vary the voltage level drawn at the ECU via a power interface 109. For example, the board may be programmed to insert a spike into a power network. This may be utilized for security related testing of the ECU and the board and monitor conditions and operation of the ECU via the microcontroller 101.

The board 100 may utilize a pass-thru interface for one or more ECUs to debug connections. The debug ports 119 may be utilized to reprogram an ECU or debugging the processor (e.g., pause the processor, access security sensitive information in the processor, or security or safety sensitive functionality in the form of program instructions, place the processor in a particular state, call an interrupt service routine, etc.), step through software instructions, read registers/memory). The pass thru-interface of the ECU debug connections may be utilized to control the ECU execution state for enabling execution of security related test-cases.

The board may include an automotive network interface 111 to communicate with an automotive network 113. Controlled interfaces for automotive networks, CAN, LIN, Flexray, Ethernet. The board may have the ability to connect to multiple communication buses on automotive networks. The board may multiplex access among multiple ECUs. The board may allow for modification of aspects of the physical layer of the network. For example, the board may utilize the network interface to insert faults or errors. The insertion of the faults or errors might be precisely timed as to interfere with security functionality that is being executed on the processor at the time the fault is inserted. The precise timing of the security functionality might be determined via precise synchronization of the board and the ECU, or via other methods such as detecting the execution of certain program functionality.

The power may be sent at a granular level to the ECU via the power interface 109. Thus, certain voltage may be sent to the specified pins of the ECU. There may be pulse generated as the power signal. For example, certain pulses may cause the ECU to operate in an unexpected manner or misbehave.

The board may include controlled general-purpose interfaces. This configuration may allow for digital and analog inputs and outputs to be monitored and overwritten. For example, a certain signal may be held for a certain time. The system may be able to observe the digital output and overwrite the output. The control board may allow for interception of the output of the ECU to modify the output. The test board can allow for voltages of 0-5v on the analog side (in one embodiment), and the system can intercept and modify what the larger network can view from the analog pin.

The board 100 may be loaded with software to allow for control of various components and ECUs. For example, various power profiles may be utilized to monitor the ECU’s activity and communication. Thus, there may be an embodiment where under a specific profile the ECU may view a signal, and send something different (e.g. different power). The board may be able to power, analog and digital inputs, and network traffic. The control network may allow for communication to other ECUs to coordinate control of one of the general purpose interfaces. For example, the toggle of a digital pin on Board 1 (e.g. a first board) in the control network could trigger the value of an analog pin of Board 2 (e.g. a second board) to decrease.

The board 100 may include a debug interface 119 or debug port 119. The board 100 may include multiple debug pass through interfaces that allow a connection between a debugger and the ECU 117. Such examples may include a JTAG connector or simple serial connectors. One goal of such an interfaces is to allow daisy-chaining of multiple boards to enable control from a single debugger.

The CAN-low signal from the ECU may be connected to an analog multiplexer 207. The analog multiplexer 207 may select between several analog or digital input signals and forwards the selected input to a single output line, in one embodiment. The selection may be directed by a separate set of digital inputs known as select lines.

FIG. 2 further illustrates an exemplar implementation of the controlled interface to an automotive controller area network (CAN). Similar implementations may be utilized to provide controlled connectivity to LIN, Flexray, Ethernet or other automotive networks. The configuration allows the uC to monitor the CAN bus, and arbitrarily overwrite bits in a transmitted or received CAN message.

The transceiver 201 receives an input from the uC GPIO pin and can be utilized by the uC to monitor messages received from the CAN bus or overwrite bits in the messages received by the ECU from the CAN bus. Transceiver 202 allows transmission of arbitrary bits or messages from the uC on the CAN bus, using as input a GPIO input from the breakout 105 in FIG. 1. The analog multiplexers, 203 and 204, driven by a common input control signal from the uC GPIO breakout allow selection of the signal transmitted on the CAN bus, between the CAN signal from the uC or the ECU.

Multiplexers 203, 204 used in conjunction with 202 can allow the uC to arbitrarily overwrite selected bits in a CAN message transmitted by the ECU. The analog to digital converter (ADC) 205 allows fine grained monitoring of the voltage level associated with messages transmitted on the CAN bus. The outputs of the ADC can be connected to the uC through the GPIO breakout connector for monitoring in the software running on the uC.

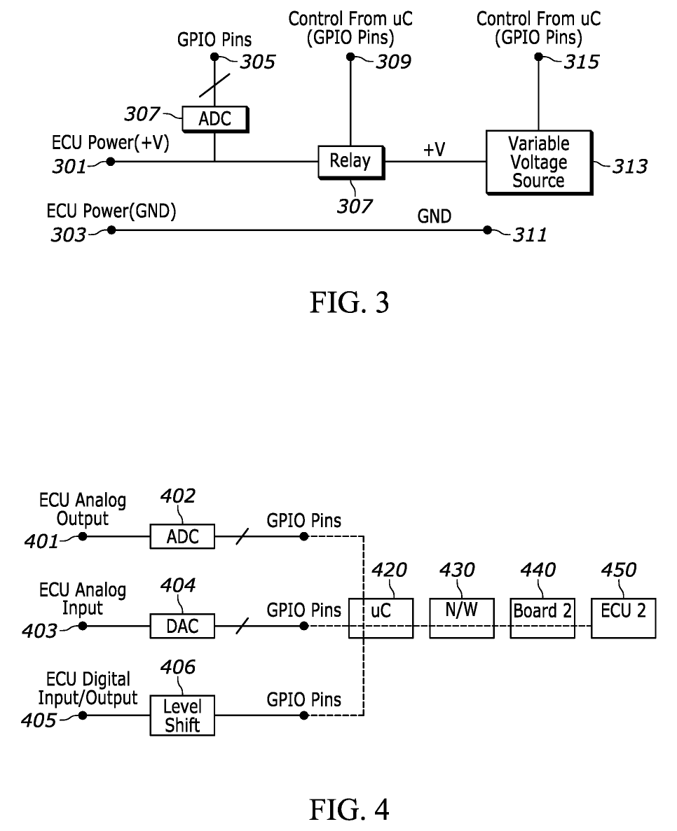

FIG. 3 illustrates an exemplar embodiment of a controlled interface that supplies power to the ECU connected to the board. The control mechanism allows software running on the uC to monitor and control the power supplied to the ECU. The power control exercised by the uC includes the ability to vary the voltage level and turn off the voltage supply for arbitrary durations.

As shown, the analog to digital converter 301 samples the power drawn by the ECU, converts it to a binary representation and reports it to the uC connected over the GPIO pins connected via the GPIO connector 105. The variable voltage source 303 allows selection of the voltage level based on an input from the uC obtained through a GPIO pin. The variable voltage source may allow for choosing the voltage level over a continuous voltage range or a few pre-determined voltage levels. The Relay 302 allows control of the connection path between the variable voltage source 303 and the ECU power pins.

The relay can be controlled from the uC through a connection from the GPIO breakout in 105. The relay allows the uC to disconnect power to the ECU for arbitrary durations. Disconnection for short duration can introduce power glitches which may result in unexpected behavior or result in security relevant issues within the ECU.

FIG. 4 illustrates an embodiment of an overview of a general purpose interface. The board may include general purpose interfaces to allow connection of analog and digital inputs and outputs of the ECU, that can be controlled by the microcontroller through software, connected to external physical sensors and actuators directly, or connected to virtual sensors and actuators through the uC control network. The configuration of such interfaces may be defined in software executing on the microcontroller to allow control of individual inputs and observe the outputs. Such interfaces can be used to emulate virtual sensors, or used to simulate arbitrary physical conditions for an ECU.

There may be various ECU analog inputs and outputs, as well as a digital ECU analog input and output. In one example, an ECU analog output 401 may be connected with an analog-to-digital converter (ADC) 402. The analog signal that is output at the ECU may be fed to the ADC 402 for conversion to a digital signal to be consumed by the microcontroller (uC). ADC 402 may be connection to GPIO pins via the breakout 105, which are ultimately connected to microcontroller 420. The microcontroller 420 may be configured to control the individual inputs and outputs. The ECU analog input 403 may be connected to a digital-to-analog converter (DAC) 404.

The DAC 404 may be utilized to take the digital signals (e.g. binary data) and convert it to an analog signal. The DAC 404 may be utilized to generate analog waveforms for testing, calibration, or communication with external analog devices. Connecting the DAC 404 to both an ECU analog input 403 and a GPIO pin allows for versatile control and communication capabilities in a digital environment while interfacing with analog components or systems. In another example, an ECU analog input may be connected to a digital to analog converter 404 where digital input to this is received from the uC 420 over the GPIO pins. The uC 420 may be configured to drive the outputs to a certain value.

The ECU digital input/output pin 405 may be connected to a level shifter 406. The level shifter may be utilized to translate signals from one logic level or voltage domain to another. This may allow for compatibility between integrated circuits with different voltage requirements. The level shifter 406 may be utilized to bridge domains between processors, logic, sensors, and other circuits.

The uC 420 may generate the signals to drive the ECU inputs and outputs in the software running on the uC 420 or they may be received over the control network interface 430 connected to other ECUs, virtual ECUs or security test boards in the network. The software controlling such interfaces may provide the ability to pass-through selected interfaces to other boards connected to different ECUs over the control network interface of the board. For example, based on the various signals (both analog and digital) from the various inputs and outputs, the microcontroller may send instructions to a Board 2440 that is in communication with the ECU 2450. Thus, the various digital and analog signals from one ECU may be sent to another board as a pass through to see various interactions and consequences of such. Modified signals may be evaluated in various environments and boards. For example, a certain command being sent to the ECU may be evaluated during a certain power condition to the ECU or to a specific pin. A network interface may be utilized to connect the microcontroller to a second electronic board (e.g. Board 2).

A security test environment according to the present disclosure is configured to allow configuration and execution of different security scenarios on an ECU connected to the board. The test PC can configure the software on the uC on the board to allow control of local GPIO ports and power ports based on the security test scenario. The tester PC may execute the test scenario by controlling the execution of the ECU software over the debug interfaces connected to the debug port chain and controlling the execution of the uC over the control network connected to the board.

A security test may be composed of a series of steps in varying order, consisting of providing certain inputs analog and digital inputs to the ECU, manipulating the output and inputs to the ECU over the automotive buses, or introducing power variations during execution of the ECU functions. Such tests may be executed on a single ECU or a set of ECUs connected in a network.

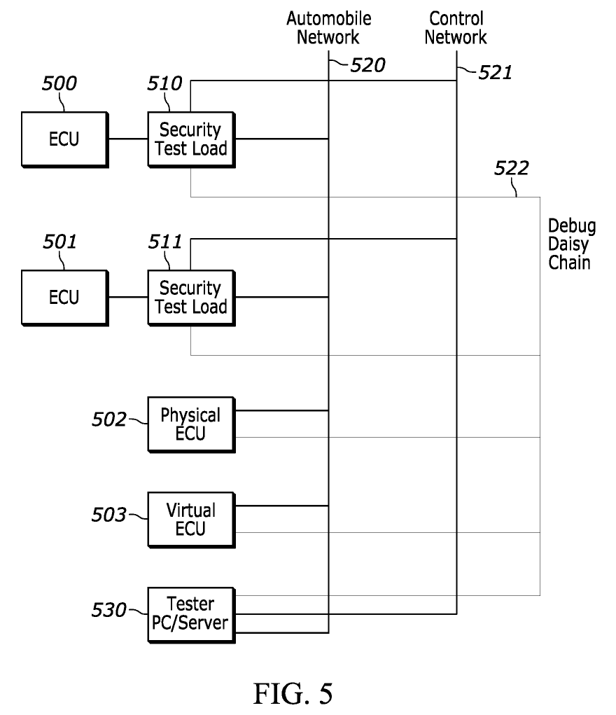

FIG. 5 illustrates an exemplar security test network that can utilize the board to configure and execute security test scenarios. Device 500, 501 may be represented by a traditional ECU to be tested connected to the testing boards 510 and 511. The ECU 502 represents an unmodified physical ECU that can be used as part of the security simulation. The ECU 503 represents a virtual representation of the ECU participating in the security test scenario.

The network 520 represents the traditional automotive network such as CAN, LIN, Flexray or Ethernet. The network 521 represents the control network connecting to each board. The control network may be comprised of wired Ethernet or Wireless networks such as 802.11, or Bluetooth. The debug daisy chain 522 is connected to the debug ports on the board and on the individual physical or virtual ECUs.

The tester PC 530 may be a regular PC or server device capable of communicating with security test network over interfaces (e.g. automobile network 520, control network 521 and debug daisy chain 522, etc.). The tester PC 530 may contain security simulations configured by a user that can be executed on the test network using the boards 510, 511 and the results may be stored retrieved and stored on the PC 530.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. An apparatus utilized for security testing one or more electronic control units (ECUs), comprising:
a memory unit configured to store one or more instructions;
a controller configured to execute one or more instructions;
a control network interface in communication with the controller, wherein the control network interface is configured to communicate instructions received from one or more control networks;
a breakout interface configured to communicate with the one or more ECUs, wherein the breakout interface is configured to send one or more instructions to the one or more ECU;
a configurable automotive network interface configured to communicate with one or more automotive networks;
a general purpose input-output (GPIO) breakout interface including a plurality of GPIO pins configured to send signals to control functionality of the apparatus;
a configurable power interface configured to supply variable power to the one or more ECUS; and
one or more debug interfaces configured to allow communication between a debugger and the one or more ECUs as associated with security testing.

2. The apparatus of claim 1, wherein the automotive interface includes a controller area network (CAN) transceiver configured to receive both a CAN-high and CAN-low signal.

3. The apparatus of claim 1, connection of the ECU CAN pins to the CAN interface described here, connection of the ECU power pins to the power connectors described here and the connection of ECU sensor inputs and outputs.

4. The apparatus of claim 1, wherein the automotive interface is configured to allow the microcontroller to overwrite specific bits in a message transmitted from the ECU to the automotive network.

5. The apparatus of claim 1, wherein the power interface is configured to allow software control of the voltage level supplied to the connected device.

6. The apparatus of claim 5, wherein the power interface power is to be disconnected to the device through software instructions on the board.

7. The apparatus of claim 1, wherein analog inputs and outputs to the connected ECU are provide from the microcontroller on the board.

8. The apparatus of claim 7, wherein the input and output values are received or transmitted from other nodes over the control network.

9. The apparatus of claim 1, wherein the control network interface is remote to the apparatus and the control network interface is a wireless transceiver.

10. The apparatus of claim 1, wherein the debug interface includes either a JTAG connector or a serial connector.

11. The apparatus of claim 1, wherein the automotive interface includes a controller area network (CAN) transceiver in communication with a first analog multiplexer in communication with a CAN-high network, a second analog multiplexer in communication with a CAN-low network, and an analog-to-digital converter.

12. The apparatus of claim 1, wherein the GPIO breakout interface is connected to a Field Programmable Array (FGPA) that is connected to the controller.

13. An apparatus utilized for security testing one or more electronic control units (ECUs), comprising:
a memory unit configured to store one or more instructions;
a controller configured to execute one or more instructions;
a control network interface in communication with the controller, wherein the control network interface is configured to communicate instructions received from one or more control networks;
a breakout interface configured to communicate with the one or more ECUs, wherein the breakout interface is configured to send the one or more instructions to the one or more ECU;
a automotive network interface configured to communicate signals to one or more automotive networks;
a general purpose input-output (GPIO) breakout interface including a plurality of GPIO pins configured to send signals to control functionality of the apparatus; and
one or more debug interfaces configured to allow communication between a debugger and the one or more ECUs.

14. The apparatus of claim 13, wherein the controller is configured to monitor signals and modify bits of the signals communicated to the one or more automotive networks.

15. An electronic board utilized for testing one or more electronic control units (ECUs), comprising:
a memory unit configured to store one or more instructions;
a controller configured to execute one or more instructions;
a control network interface in communication with the controller, wherein the control network interface is configured to communicate instructions received from one or more control networks;
a breakout interface configured to communicate with the one or more ECUs, wherein the breakout interface is configured to send the one or more instructions to the one or more ECU ;
a automotive network interface configured to communicate signals to one or more automotive networks; and
a general purpose input-output (GPIO) breakout interface including a plurality of GPIO pins configured to send signals to control functionality of the apparatus, wherein the controller is further configured to monitor interaction of the one or more ECUS in response to signals at one or more automotive networks and the signals sent by the GPIO breakout interface.

16. The electronic board of claim 15, wherein the electronic board is configured to connect with a second electronic board including a second automotive network interface and second breakout interface.

17. The electronic board of claim 15, wherein the plurality of GPIO pins include both analog pins and digital pins in communication with the one or more ECUs.

18. The electronic board of claim 15, wherein the automotive network interface communicate signals to one or more automotive networks without a host computer.

19. The electronic board of claim 15, where in the GPIO breakout interface is configured to emulate one or more sensors configured to interact with the one or more ECUs.

20. The apparatus of claim 15, wherein the GPIO breakout interface is connected to a Field Programmable Array (FGPA) that is connected to the controller.
